(19) United States
(12) Patent Application Publication
(10) Pub. No.: US 2014/0300285 A1
(43) Pub. Date: Oct. 9, 2014

(54) Variable LED Light Illumination

(71) Applicant: Alan Medak, Claremont, CA (US)

(72) Inventor: Alan Medak, Claremont, CA (US)

(21) Appl. No.: 14/245,260

(22) Filed: Apr. 4, 2014

Related U.S. Application Data
(60) Provisional application No. 61/809,168, filed on Apr. 5, 2013.

(51) Int. Cl. H05B 33/08

(52) U.S. Cl. CPC H05B 33/0815; H05B 33/0845
USPC 315/186

(57) ABSTRACT

Improvements in lighting are disclosed where the light uses PWM to gradually increase the illumination to reduce illumination shock as the lighting abruptly changes. PWM essentially changes illumination by using square waves where the width of the square wave is adjusted to vary the amount of visible illumination. The frequency of the pulse must be sufficiently fast enough to eliminate visible pulsation. The lighting is designed in lengths of one and two feet long where the one or two foot sections that can be daisy chained together to increase to decrease the length to fit the application. The LED's can be a single color of white or blue or can be a tri-color LED that can create nearly any desired color or variable color that can create an appearance of a sunrise or sunset.

### CROSS REFERENCE TO RELATED APPLICATIONS

This application claims the benefit of Provisional Application 61/809,168 filed Apr. 5, 2013 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in a lighting system. More particularly, the present variable LED light illumination device provides an LED lighting system that gradually increases the amount of illumination by gradually increasing the pulse width of power being sent to an array of LED's to reduce the shock of an abrupt change in illumination.

2. Description of Related Art Including Information Disclosed under 37 CFR 1.97 and 1.98

For many applications abrupt changes in illumination intensity can be harmful to living creatures from animals to plants. While the change in illumination applies to creatures it also has application for phone docking stations, health and we'll being lights for apartments and locations with continuous months of darkness like Iceland. Also agriculture like chicken and egg ranches. I would also imagine faster but still gentle ramp up inside led bulbs and led light tubes.

Enclosed living spaces for animals and creatures have evolved from simple jars, or boxes to elaborate containers that house a small ecosystem of living creatures. As these containers have evolved the need to properly care for the occupants held within also has evolved and become more elaborate. One area in particular has been with proper illumination that allows for a healthier environment within the container as well as allowing owners to better view and appreciate the investment within. In the market are various products to light glass aquarium for fish, animals and reptiles for both the hobbyist and for commercial applications. These light fixtures can use various light sources, incandescent lamps, fluorescent lamps or LED lamps. These fixtures are usually attached to a switch or a timer to control the number of hours the lamps are on in the day. The lamp turn on is abrupt, which in many cases startle the animals in the aquarium. Fish are particularly sensitive. Some exotic fish can attempt to jump out of the tank when the light suddenly comes on while other fish can be so stressed that they can die within hours of the sudden light application. Many fish need a natural application of light after prolonged darkness.

A number of patents and or publications have been made to address these issues. Exemplary examples of patents and or publication that try to address this/these problem(s) are identified and discussed below.

An early version of lighting that uses LED elements is found in U.S. Pat. No. 5,165,778 issued on Nov. 24, 1992 to John D. Matthias et al disclose an Aquarium Lighting System. The aquarium light uses a fluorescent light with a plurality of individual LED's that are connected to wires that can be positioned with the aquarium. While this patent provides some LED illumination, the illumination is points of light, with the majority of light coming from a fluorescent light. This patent does not provide gradual illumination.

While LED lighting has evolved some have attempted to alter the brightness of LED's using pulse width modulation. U.S. Pat. No. 6,586,890 issued on Jul. 1, 2003 to Young-Kee Min et al discloses an LED Driver Circuit with PWM Output. The PWM circuit allows a user to adjust the light intensity by changing the pulse width that powers the LED's. While this provides variable amount of light intensity it does not gradually increase the light intensity.

A patent, U.S. Pat. No. 7,436,134, on a Cyclical Aquarium and Terrarium Light was issued on Oct. 14, 2008 to Matthew B. Levine. This patent uses two separate lights where one light has a variable intensity and a second light that in either completely on or completely off. The light from the variable first light can gradually be illuminated, but can't provide sufficient illumination and therefore once the first light is a full intensity the second light is illuminated. While this lighting system provides some change in illumination, the variable illumination is not performed by pulse width modulation (PWM) and there is still some abrupt change when the second light is turned on or off.

An elongated strip of LED's was disclosed in U.S. Pat. No. 8,230,815 that issued on Jul. 31, 2012 to Dennis Fredricks. This patent discloses an elongated strip of LEDs to illuminate an aquarium. The elongated strip allows easier access to the inside of the aquarium. Multiple strips can be individually powered to change the amount of light with illumination intensities based upon the number of strips of light. This patent does not disclose PWM to change the intensity of light.

Published patent application US 2007/0253196 was published on Nov. 1, 2007 to Patrick F. Ormister discloses an LED Aquarium Light. The LED aquarium light uses an array of light to illuminate an aquarium. Each LED can be a different color and each LED can be individually powered to change the color and the intensity of light within the aquarium. The intensity of the illumination is not LED's is controlled with PWM to gradually change the illumination of the LED's.

What is needed is an elongated illumination strip that provides a gradual change in illumination to simulate natural light changes the creatures within an aquarium or terrarium would experience in their natural environment. The proposed disclosure provides a solution for these requirements.

### BRIEF SUMMARY OF THE INVENTION

It is an object of the aquarium variable LED light to be powered by a wall outlet. The wall outlet is connected to a transformer to reduce the voltage to a safer level. Because the device is powered by an outlet a user can plug the device into a switchable outlet or into a timer. This allows an owner to abruptly apply power to the device and the device then gradually increases the illumination to reduce illumination shock to within the aquarium or terrarium. A person can then turn on or off the lighting at any time without causing an illumination shock.

It is an object of the aquarium variable LED light to use pulse width illumination (PWM) to change the illumination intensity. PWM essentially changes illumination by using a square type wave where the width of the square wave is adjusted to vary the amount of visible illumination. The frequency of the pulse must be sufficiently fast enough to eliminate visible pulsation.

It is another object of the aquarium variable LED light to be designed as an expandable lighting system. Aquarium and terrariums are available in a variety of standard and custom lengths. The aquarium variable LED light is designed in lengths of one and two feet long where the one or two foot sections can be daisy chained together to increase to decrease the length to fit most aquariums or terrariums. Additional aquarium variable LED lights can be doubled back to increase the amount of illumination or to add lighting in a different location or from a different direction.

It is still another object of the aquarium variable LED light to be available in different colors. Some creatures, fish and landscape react, phosphorus or glow based upon the illumination that shines. The LED's can be a single color of white or blue or can be a tri-color LED that can create nearly any desired color or variable color that can create an appearance of a sunrise or sunset.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a prior art figure of LED lighting used for illumination.

FIG. 2 shows a preferred embodiment using a diming module.

FIG. 3 shows a block diagram of the diming module.

FIG. 4 shows a diagram of the diming module.

FIG. 5 shows a contemplated timing circuit.

FIG. 6 shows a contemplated up/down circuit.

FIG. 7 shows the timing circuit is supplied by Vps_out to lower line voltage to 24 volts.

FIG. 8 shows the resistor R6 connected to a pulse width source.

FIG. 9 is an embodiment that incorporates the fixed PWM method into the circuit.

FIG. 10 shows R6 is connected to the output of the PWM thru diode D3.

FIG. 11 shows a perspective view of the variable LED light installed on an aquarium.

FIG. 12 shows a perspective view of just the variable LED light.

FIG. 13 shows a cross sectional view of the variable LED light.

### DETAILED DESCRIPTION OF THE INVENTION

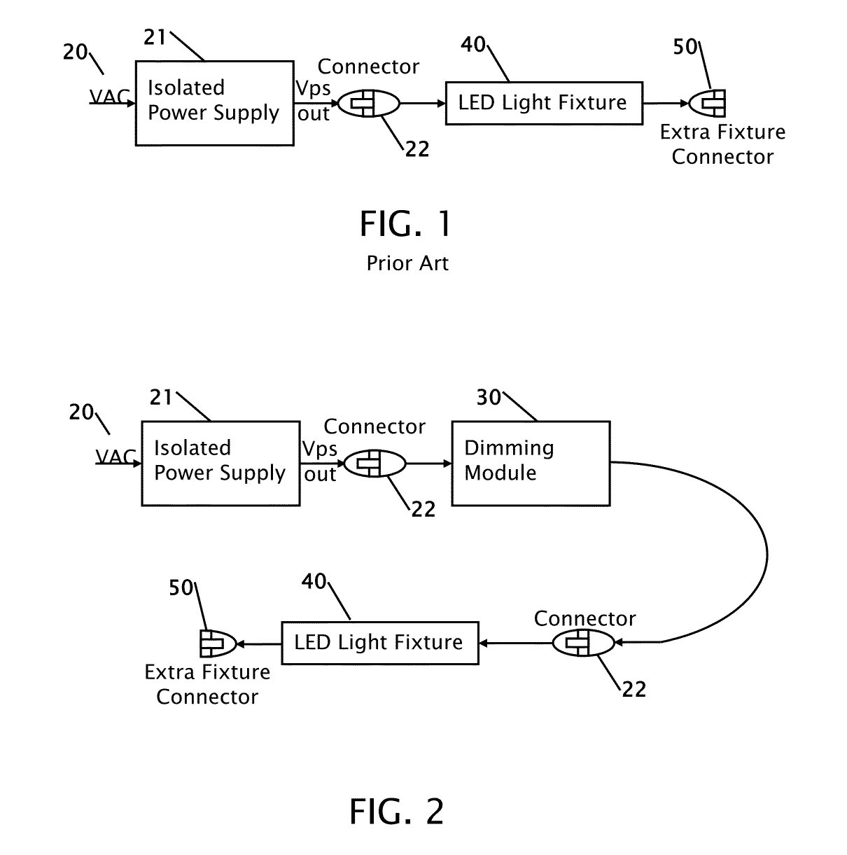

FIG. 1 shows a prior art figure of LED lighting used for gradual change of illumination. For this circuit description, the LED fixture 30 will be used; however it equally applies to the other lamp sources. In the case of animal or plant enclosures, the voltage applied to the LED's have to be low voltage for safety. One such implementation would have a galvanic isolated power supply connected to the AC mains 20 of 120 VAC or 230 Vac with a lower voltage DC output. The voltage needs to be below 42V for UL safety. A commonly voltage is 24 Vdc. To connect the isolated power supply 21 to the lamp fixture 40, an in-line connector 22 is used. To connect additional LED light fixtures an extra connector 50 is available. The power supply can contain batteries or other power storage means that allows the illumination to be slowly decreased without incoming power to the power supply 21. When incoming power is terminated the circuit can detect the disruption or application of power and can begin to alter the illumination intensity.

FIG. 2 shows a preferred embodiment using a diming module 30. If instead of turning on the LED's suddenly, the light could be slowly ramped up emulating natural light which will prevent plant and animal stress. A simple low cost diming module 30 can be inserted in line between the isolated power supply 21 and LED light fixture 40 to ramp up the light as power is turned on. The ramp-up time can be adjusted from minutes to hours to emulate the rising sun.

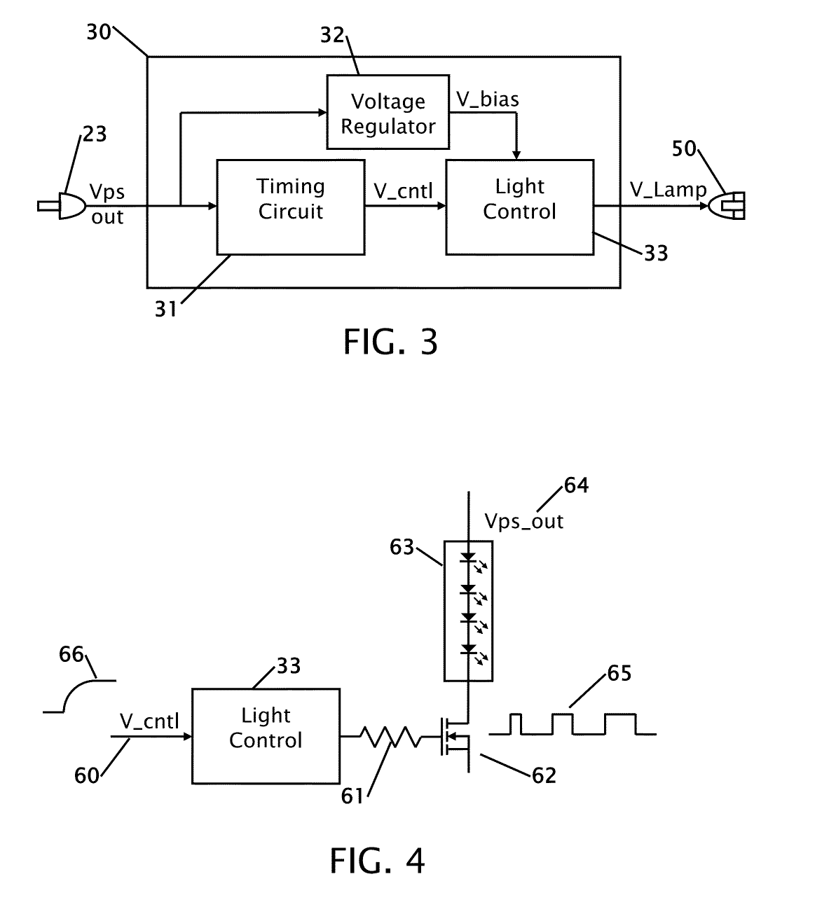

The dimming module consists of three functional circuits, voltage regulator, a method to control light output and a timing delay circuit. FIG. 3 shows a block diagram of the diming module.

Voltage Regulator

The voltage regulator 32 supplies bias power to the circuits that can't run on Vps_out voltage. This voltage regulator 32 can be linear or switching regulator.

Method to Control Light Output

Dimming is accomplished by having a voltage or current controlled dimming function. A control voltage from a minimum value to a maximum value can control the current to the LED's in many ways. In one preferred embodiment the method to dim the LED's is to place an electronic switch like a FET Q4 in series with the negative lead of the fixture and connect the positive lead of the fixture to Vps_out as shown in FIG. 4.

By pulse width modulating the electronic switch, in response to a control signal 60 the current in the LED's 63 can be modulated with a duty cycle 65 anywhere from 0% to 100%. The light level of the LED's is increased as the duty cycle increases from 0 to 100%. By controlling the rate at which the duty cycle 65 increases the LED's 63 will change slowly from no light to full light level. Any pulse width modulator can be used to accomplish this diming function as long as it can be controlled by a signal. The signal needed to control the dimming level needs to come from a timing circuit to control the rate at which the light level increases.

To control the level of dimming and ramp rate, a simple timing circuit outputs a voltage ramp 66 to the input 60 of the pulse width modulator circuit. A specific implementation of the dimming module is shown in FIG. 4. Light control 33 could be a controllable power supply as well if current regulation is built into the fixture. Another contemplated option is to have controlled current source if the current regulation were not built in to the fixture. A current limited power supply is an example of a current source. In FIG. 4 the signal from the light control 33 passes through a resistor 61 to turn power through the FET 62 that drives the LED's 63 connected to Vps_out 64.

Timing Control Circuit

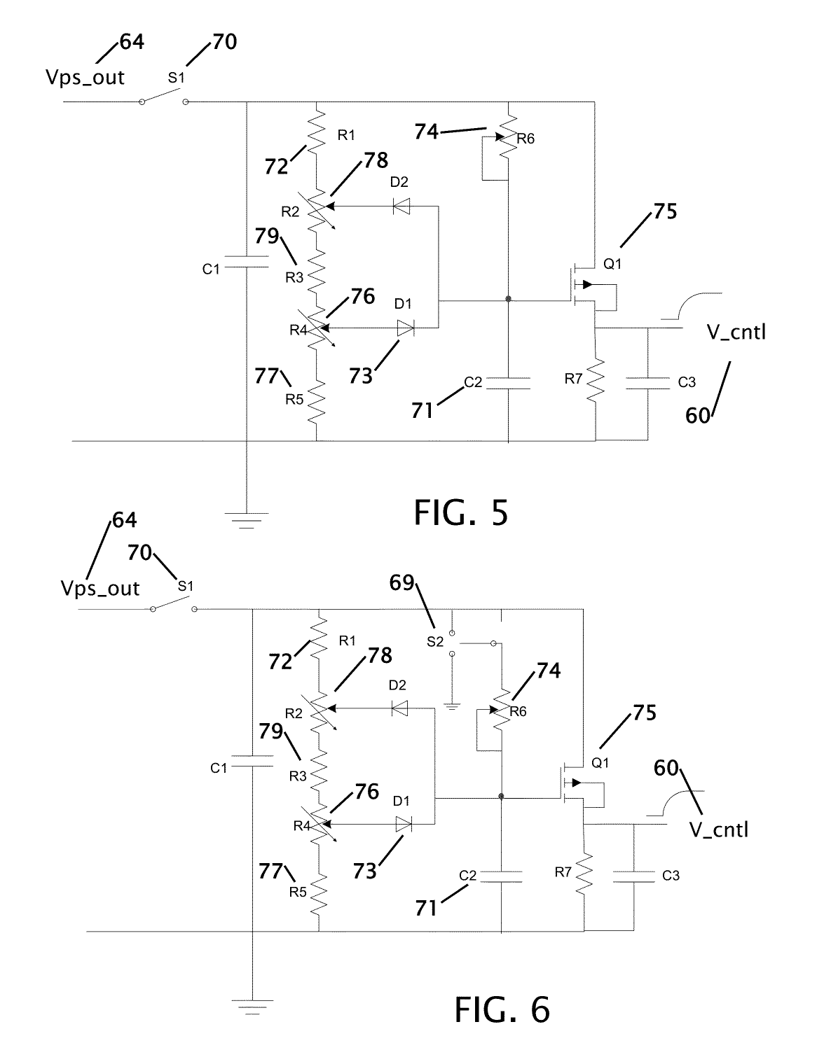

FIG. 5 shows a contemplated timing circuit. Initially, when S1 70 is open the voltage at C2 71 and V_cntl 60 are zero. When S1 70 is closed Vps_out 64 from the power supply is applied to the timing circuit. Resistor network, R1 72, R2 78, R3 79 and diode D1 73 quickly charge C2 71 to a just below a threshold voltage to keep V_cntl 60 at zero. Resistor R6 74 being a large value slowly continues to charge C2 71 causing FET Q1 75 to enter the linear region. Q1 75 is configured as a voltage follower circuit such that the voltage at V_cntl 60 will be less than the voltage on C2 71 by the gate source threshold voltage of Q1 75.

Timing control is key to the dimming module. Charging C2 71 with R6 74 can create a ramp of voltage at V_cntl 60 taking anywhere from 2 minutes to over and hour depending on the setting of R6 74 and the value of C2 71. Although R6 74 is shown as a potentiometer, it could also be several resistors with a switch to set the duration of the ramp. As C2 71 charges, the current from R6 74 is prevented from flowing into R4 76 and R5 77 by back biasing Diode D1 73. To control the maximum voltage of V_cntl 60, potentiometer R2 78 can be set to control the value at the end of the ramp. This value can be less than the maximum light level possible with the fixture.

Normally the circuit is configured so upon turn on the LED's are extinguished until C2 71 starts charging via the current in R6 74. In some application it might be desirable the have the light level to start at a minimum value that is not zero. By adjusting the value of R4 76 that minimum on turn on can be adjusted. Typically after S1 70 is turned on the minimum V_cntl 60 is reached in 5 to 10 seconds while the timing ramp is in the order of minutes to hours to change V_cntl 60 from minimum to maximum. When S1 70 is opened after completion of the desired timing duration the circuit will reset in about 3 to 5 seconds.

The present preferred embodiment demonstrates a circuit that ramps up the light level slowly when S1 70 is turned on quickly drops the light level when S1 70 is again opened. The switch 70 can be an electronic or mechanical timer purchase in a store to turn on and off the power supply. In this embodiment, the ramp time is adjustable from minutes to hours by adjusting the value of R2. The ramp down time is always less than 3 seconds. The illumination level can also be set to a level that is below full intensity by stopping the ramp of PWM at a level that is below 100%.

In another contemplated embodiment it might be desirable to have the light level ramp up slowly and ramp down slowly. FIG. 6 shows a contemplated up/down circuit.

Disconnecting R6 74 from Vps_out 64 directly and inserting switch S2 69 the slow ramping can be controlled by the position of S2 69. When S2 69 is in the upper position, the circuit is ramping up slowly. When switch 69 is set to a low position the circuit is ramping down slowly. Although this switch 69 is shown mechanically, it can be an electronic switch controlled by other circuitry. There can also be another Vps_out 64 power supply on a separate circuit. If S1 70 is kept on all the time and R6 74 is connected to the second power supply turning on and off of the second power supply will cause the module to ramp up slowly and ramp down slowly. In the configuration shown the ramp up and ramp down times are the same, but this could be changed by adding another resistor in parallel with R6 74 but with at diode is series to change the ramp times up or down.

Still another alternate embodiment would be to disconnect R6 74 from the 24V supply and connect R6 74 to a switch which connects it to 24V or 0 V while the power supply remains on. With this configuration, the lamp will ramp up in minutes or hours depending on the value of R6 74 and C2 71 when R6 74 is connected to 24V. When R6 74 is connected to ground, the lamp will ramp done to zero in minutes or hours depending on the value of R6 74. One method of implementing this function is to have two power supplies. The first power supply is continuously on, while the second supply is connected to R6 74. The second supply connected to an AC timer controls the on time of the LED with the associate ramp up and down.

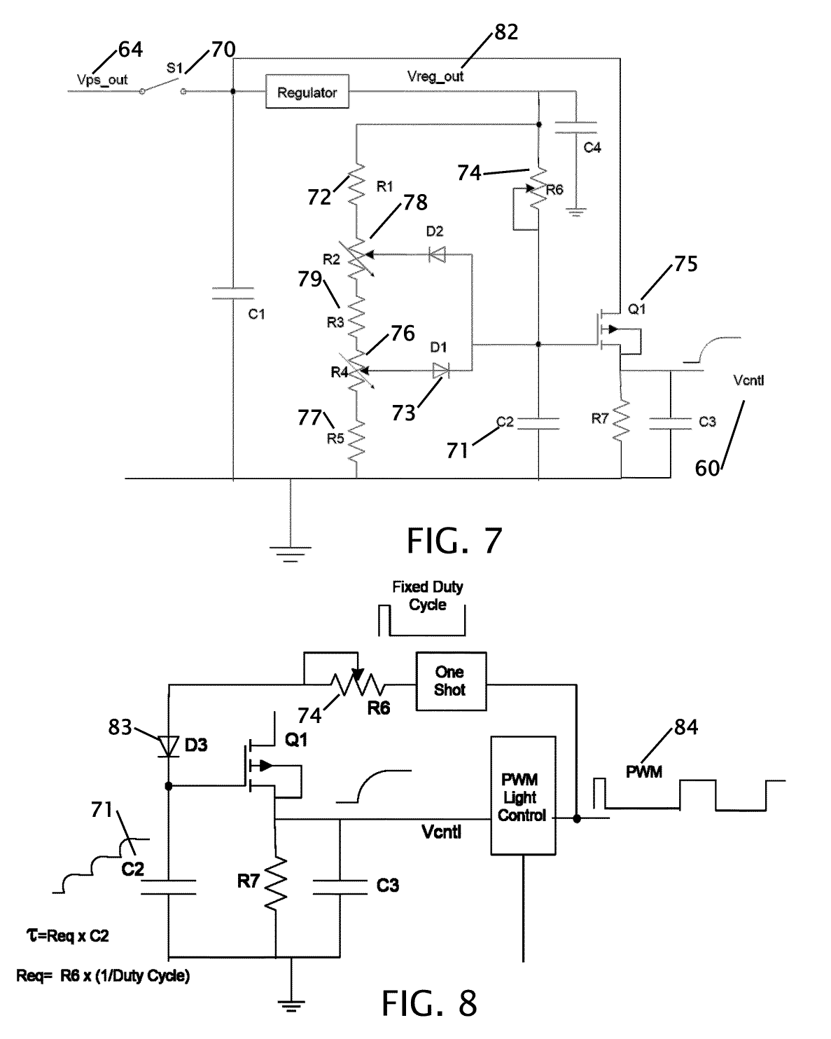

In FIG. 7 the timing circuit is supplied by Vps_out 64 which is the rectified voltage out of the plug in transformer to lower line voltage to a safe level like 24 V. If Vps_out 64 isn't regulated timing can modified by line voltage changes due to surges and brown outs. If a regulator is added, a stable voltage Vreg_out 64 is created to stabilize the timing circuit of R6 74 and C2 71. As shown in FIG. 7, the regulator output voltage 82 can be greater or less than Vps_out 64.

The timing circuit cap is set from seconds to an hour depending on the value of R6 74 and C2 71. To get long times the value of R6 74 has to be greater than 1 Meg Ohm. When high values of R6 74 are used the leakage in C2 71 can affect the proper timing.

If the resistor R6 74 is connected to a pulse width source as shown in FIG. 8, Capacitor C2 71 is charged only when the resistor R6 74 is pulled high. When R6 74 is pulled low the Diode D3 83 prevents discharge of C2 71 until the next positive pulse. For narrow duty cycles the time to increase the voltage on C2 71 takes a longer time. The rate of charge speeds up for longer duty cycles. The time constant of an RC circuit is ·=R6 74×C2 71. When a PWM signal 84 is applied to R6 74, this effectively increases the value of R6 74 to Req=R6 74×(1/Duty Cycle). The circuit shown in FIG. 8 uses a one shot triggered by the PWM signal out of the PWM light control. This will generate the duty cycle in synchronism with the output PWM. Other methods can be used to generate the PWM signal to increase the effective value of R6 74.

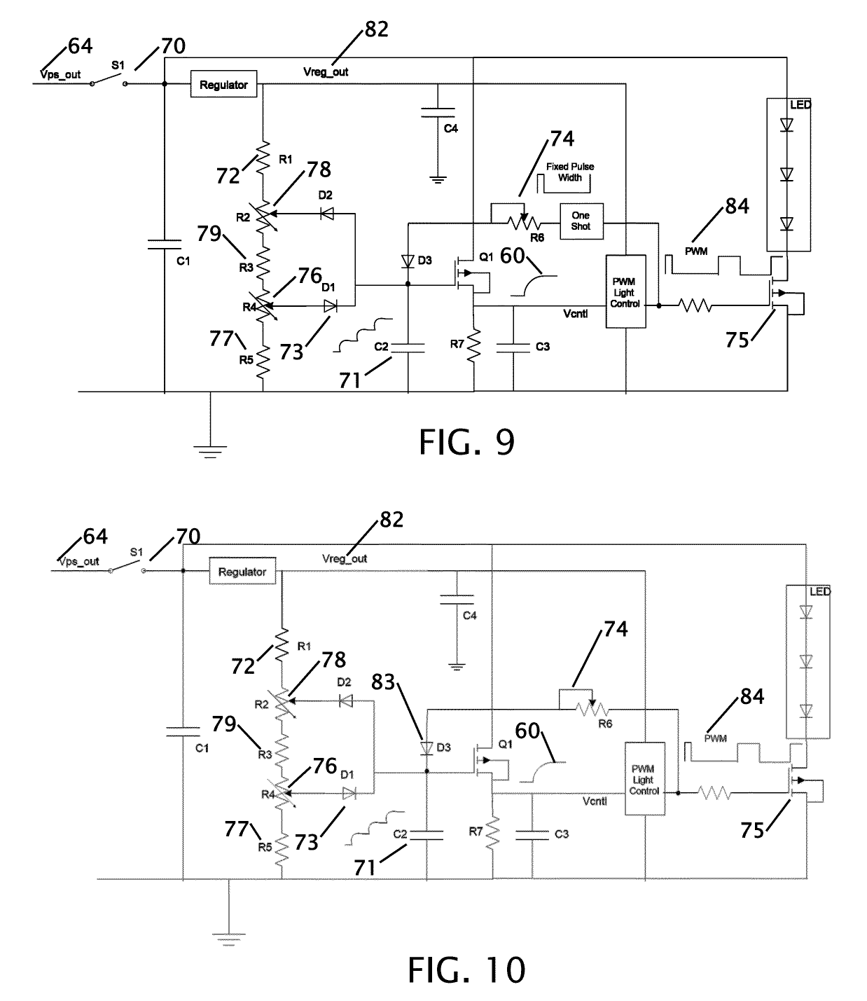

FIG. 9 is one method to incorporate the fixed PWM method into the circuit. Another method which simplifies the charging is to feed back the PWM signal from the LED driver. This will provide a variable charging rate. Initially, the pwm is low so each charging step is small. As the control voltage V_cntl increases the PWM signal increases and the each charging step increases. This effectively creates a non-linear Req out of R6 74 so the charging at low light levels is slow. Later when the PWM increases each charge step increases. The eye has a logarithm sensitivity which can detect small increases in light level when dim, but has a harder time seeing steps in light levels when bright.

In FIG. 10, R6 is connected to the output of the PWM thru diode D3 83. By connecting the timing resistor to PWM signal, the charging of C2 71 occurs only when the output of the PWM Light Control is high. When the PWM signal is low, charging is suspended. The quantity of charge current depends on the on-time of the PWM signal. As C2 charges the pulse width increases which feeds back increasing current to C2 71.

The PWM circuit with R6 74 and D3 83 effectively increases the average value of the resistor. A much small resistor can be used to get long times from the timing circuit. Although these circuits show a particular implementation, other methods could be used to generate a long time constant. These circuits demonstrated an application for Aquarium containing fish, however this type of circuit can be used on any contained animal, like Lizards, Hamsters and any other type of pet. It can also be used as a gradual light alarm for a sleeping human. This can be effective for people that sleep odd hours and this gradual light increase can simulate the rising sun when it is dark outside.

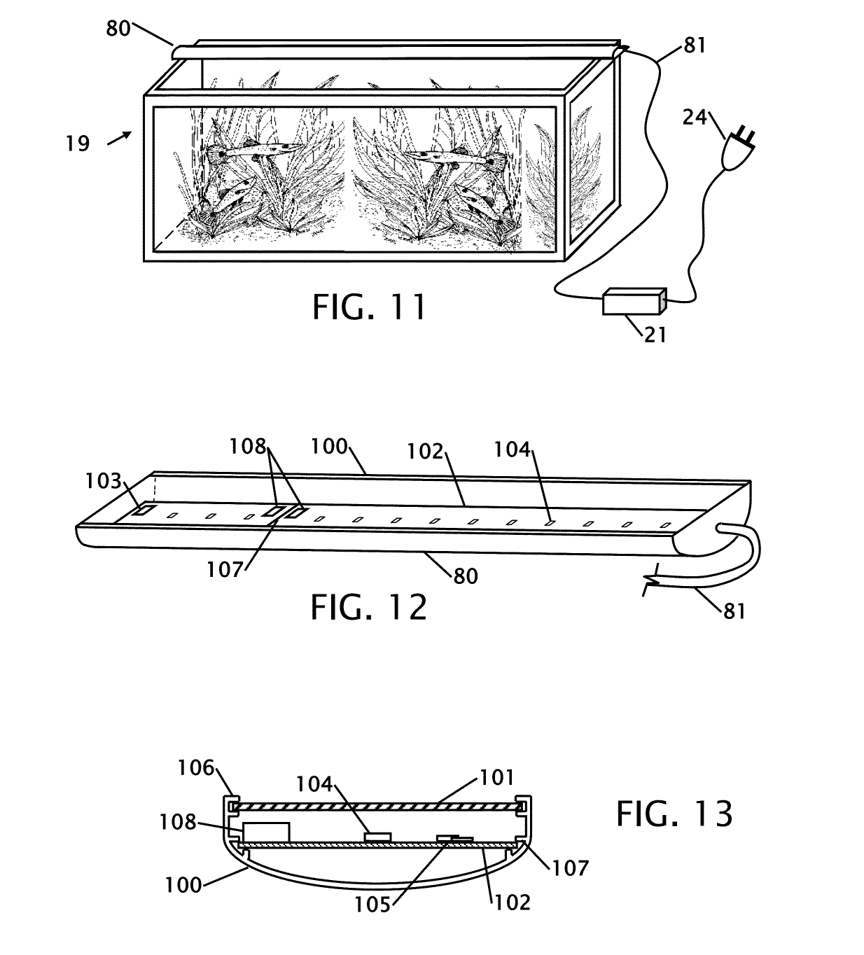

FIG. 11 shows a perspective view of the variable LED light 80 installed on an aquarium 19 and connected by cord 81. From this figure the isolated power supply 21 is shown where the isolated power supply is connectable to a standard plug 24. The aquarium variable LED light is preferably configured in an elongated embodiment to fit along the elongated length of an enclosure 19. The elongated configuration allows the variable LED light to be fabricated in a variety of lengths with limited changes to manufacturing. While an aquarium/terrarium enclosure is shown in this figure the variable LED light 80 can be used in a coup, on a fence above a door, above a window or above a bed. It is further contemplated that the illumination can be orientated to provide variable lighting from a side, bottom or as indirect lighting.

FIG. 12 shows a perspective view of just the variable LED light 80. This inside view of the aquarium variable LED light 80 shows the extruded housing 100 with a circuit board 102 configured with a plurality of LED's 104 soldered to the circuit board 102. This figure approximates a three foot light with a division 107 between a two-foot section on the right and a one-foot section on the left. The two sections are daisy chained electrically together with connection between connectors 108. An end connector 103 allows for connection to additional LED lights. The circuit for the variable illumination is soldered to the same circuit board 102 to prevent a user from accidentally turning the light from off to completely on. The multiple modules are connected together and can be progressively illuminate with one section and then another or all of said modules can adjust the brightness at the same time.

FIG. 13 shows a cross-sectional view of the variable LED light. The major body of the variable LED light is formed from an extrusion 100. The extrusion 100 is configured with a plurality of lips or tables 106 and 107 where the lips or tabs 107 retain an elongated circuit board 102 and lips or tabs 106 support a clear or filtered lens or diffuser 101. The circuit board has a plurality of light emitting diodes (LED's) 104 soldered to the top of the circuit board 102. The PWM illumination circuitry and components 105 are also soldered to the circuit board 102. The daisy power connector 108 is shown soldered at the side of the circuit board 102.

While only one color LED is shown and described it is also contemplated that the LED is a tri-color LED that allows for setting a desirable color, or providing a colored sunrise or sunset. It is also contemplated to populate the circuit board with different colored LED's to provide different lighting to different areas of the aquarium, for example illuminating the sides with different colors or intensities as the center of the aquarium.

Thus, specific embodiments of a variable LED light have been disclosed. It should be apparent, however, to those skilled in the art that many more modifications besides those described are possible without departing from the inventive concepts herein. The inventive subject matter, therefore, is not to be restricted except in the spirit of the appended claims.

1. A variable LED light comprising:
a plurality of LED's;
a pulse width modulated circuit that gradually alters the perceived brightness of said plurality of LED's, and
wherein said altering of said brightness is by increasing said perceived brightness from completely off to a first desired level of brightness over an adjustable first duration of time, and by altering said perceived brightness from said first desired level of brightness to a second desired level of brightness over an adjustable second duration of time.

2. The variable LED light according to claim 1 wherein said pulse width modulation includes a timing control.

3. The variable LED light according to claim 1 further includes an isolated power supply.

4. The variable LED light according to claim 1 wherein said increasing said perceived brightness simulates a sunrise.

5. The variable LED light according to claim 1 wherein said brightness from said first desired level to said second desired level simulates a sunset.

6. The variable LED light according to claim 1 wherein said brightness from said first desired level to said second desired level has a greater level of illumination.

7. The variable LED light according to claim 1 wherein application abrupt application of electricity to said aquarium variable LED light is not abruptly applied to said plurality of LED's.

8. The variable LED light according to claim 1 wherein abrupt removal of electricity to said aquarium variable LED light is not abruptly removed to said plurality of LED's.

9. The variable LED light according to claim 1 wherein a width of the square wave is adjusted to vary the amount of said brightness.

10. The variable LED light according to claim 1 wherein said plurality of LED's is configured as a module.

11. The variable LED light according to claim 10 wherein more than one module is connectable together.

12. The variable LED light according to claim 11 wherein when multiple said modules are connected together all of said modules adjust said brightness at the same time.

13. The variable LED light according to claim 1 wherein said variable LED lighting provides illumination for an aquarium, terrarium or tank.

14. The variable LED light according to claim 13 wherein said light further includes a support structure that supports said variable LED light on and edge of said aquarium, terrarium, bed, doorway, cage or tank.

15. The variable LED light according to claim 1 wherein said variable LED lighting provides illumination for plants or animals.

16. The variable LED light according to claim 1 wherein said LED's are multi-colored.

17. The variable LED light according to claim 16 wherein said multi-colored LED's are illuminated in a specific order that simulates colors from sunrise to overhead sunlight.

18. The variable LED light according to claim 16 wherein said multi-colored LED's are illuminated in a specific order that simulates colors from overhead sunlight to sunset.

19. The variable LED light according to claim 1 further includes a power supply that converts power from a wall plug to voltage used in said aquarium variable LED light.

20. The variable LED light according to claim 19 wherein said power supply further includes a power storage device that provides power to said variable LED light to reduce said illumination without supplied external power.
